(19) United States
(12) Patent Application Publication
(10) Pub. No.: US 2004/0140733 A1
(43) Pub. Date: Jul. 22, 2004

(54) Electrostatic actuator with a multiplicity of stacked parallel plates

(76) Inventor: Christopher Guild Keller, El Cerrito, CA (US)

Correspondence Address: CHRISTOPHER GUILD KELLER, 905 POMONA AVENUE, EL CERRITO, CA, 94530, US

(21) Appl. No.: 10/755,158

(22) Filed: Jan. 9, 2004

Related U.S. Application Data
(60) Provisional application No. 60/439,836, filed on Jan. 13, 2003.

(51) Int. Cl. H02N 1/00

(52) U.S. Cl. 310/309

(57) ABSTRACT

A micromechanical electrostatic actuator, having a multiplicity of parallel plates, for general use in micromechanical devices such as microgrippers. High force is due to the large confronting area of the charged plates, and large displacement for the stack as a whole is due to the cumulative displacements of the individual plates. The electrical pathways connecting plates of like polarity are provided by folded cantilever beams at the periphery. Mechanical connection between adjacent plates is provided by electrically insulted compliant cantilever beams at the periphery, or alternatively by an open cell foam between the confronting plates.

### PATENT APPLICATION

This patent application claims the benefit of provisional patent application 60/439,836 filed on Jan. 13, 2003.

### BACKGROUND

1. Field of Invention

The field of the invention is microfabricated electrostatic actuators for use in micromachines and microelectromechanical systems (MEMS) in general.

2. Discussion of Prior Art

Prior art microfabricated electrostatic actuators include parallel plate (e.g., U.S. Pat. No. 4,674,319), and interdigitated finger (“comb drive”) (e.g., U.S. Pat. No. 5,025,346) designs. The micromechanical devices of the prior art that are made from silicon by the methods of microfabrication have only one movable layer of silicon. There are two categories: parallel plate (with motion perpendicular to the plane), and comb drive (with motion in the plane). The parallel plate geometry can provide high force because there is a large area of the confronting electrodes (plates), but only a small displacement of motion due to the small gap separating the two electrodes. They do not have a multiplicity of movable plates in a stack, so there is no cumulative displacement possible. The comb drive geometry allows a large displacement, but only a weak force because it is only the narrow edges of the electrodes that are confronting each other.

U.S. Pat. Nos. 5,485,437 and 5,521,452 by Gregg describes a stacked parallel plate actuator with metal conductive plates separated by rubber supports within a rubber envelope that is filled with a dielectric liquid. The viscosity of the liquid results in the generation of frictional heating when the device is actuated, and also prevents rapid motion of the device.

U.S. Pat. Nos. 6,184,608 B1, 6,255,758 B1 and 6,411,013 B1 describe an electrostatic actuator comprised of a stack of flexible polymeric plates wherein at least one set of plates is corrugated.

U.S. Pat. No. 5,682,075 describes an electrostatic transducer having a plurality of parallel plates separated by elastomeric spring elements.

All of the devices of the prior art having a stack of more than two plates rely on polymeric components. This limits their use to applications that are not subject to high temperature. Also they all specify that the polymers are not brittle, so they are above their glass transition temperature (Tg). This further excludes their use from applications subject to low temperature. By relying on polymeric elastomer elements above their Tg, there is a further detriment from internal friction as polymeric side chains slide past each other when the actuator is compressed or extended. The mechanical energy lost to internal friction acts to heat the structure, so cooling means may be required under heavy use. Elastomers are prone to outgassing, so are not suitable in applications having surfaces nearby that must remain clean (such as mirrors and lenses). Polymers are vulnerable to creep over time, and will lose their original calibration. Yet another shortcoming of the prior art stacked plate designs is that they are not easy to assemble. What is needed, and is provided in the present invention, is a design geometry that allows fabrication from silicon, because silicon is immune to all of these problems.

### OBJECTS AND ADVANTAGES

The objects of the present invention, and the advantages achieved, are high electrostatic force and high displacement, in a small volume actuator. High force is achieved by the large confronting area of the conductive plates, and by the small gap that separates them. The high displacement is achieved by stacking a multiplicity of plates such that the displacement of the stack as a whole is the sum of the individual displacements of the component plates. For example a stack having 100 plates, each of which can move one micrometer with respect to the plate below it gives a total output displacement of 100 micrometers at the top of the stack. A stack may have tens, hundreds, or thousands, of plates if desired.

In contrast to other silicon based MEMS actuators which remain attached to the silicon substrate they were fabricated on, this invention is made by assembling silicon pieces that have been removed from the wafers used in fabrication so that the final actuator is not an integrated part captive to a silicon substrate, but is an independent component free to be installed as a modular unit in any machine.

By using silicon as the structural material, the device is suitable for applications ranging in temperature from cryogenic to about 500 C. Silicon does not exhibit the internal friction experienced by elastomers, so greater mechanical efficiency is possible. Silicon will not creep, or outgas contaminants. By using the methods of silicon microfabrication (e.g., photolithography, and etching) it is possible to make the symmetrical plate geometry with attached connection beams that is needed to for convenient and rapid assembly of a stack.

### DESCRIPTION OF DRAWINGS

FIG. 1: Schematic side view representation of the elements of the invention.

FIG. 2: Schematic side view of the invention with voltage applied to cause axial compression of the spring elements.

FIGS. 3a-d: Embodiment with octagonal plates, showing connection logic, disassembled.

FIG. 4: Perspective view of embodiment with octagonal plates assembled.

FIGS. 5a-b: Schematic cross sections showing mechanical and electrical connections between the plates in the assembled actuator.

FIG. 6: Schematic cross section of the actuator in its protective enclosure.

FIG. 7: Plan view schematic cross section of the actuator installed on a micromechanical device (microgripper)

FIGS. 8a-b: Schematic cross sections showing electrical and mechanical connections between the plates of an embodiment having square plates separated by a compliant foam.

FIG. 9: Plate design for embodiment having rigid walls housing the movable plates.

FIG. 10: Schematic side view cross section of embodiment having rigid walls housing the movable plates with no voltage applied.

FIG. 11: Embodiment of FIG. 10 with enough voltage applied to pull the plates together.

### LIST OF REFERENCE NUMERALS

2 stack of plates held together by compliant beams

4 grounded plates

6 high potential plates

8 gap space when no voltage is applied

10 electrically conducting connection between grounded plates

11 electrically conducting connection between high voltage plates

14 ground terminal

16 high potential terminal

18 electrically insulated mechanical connector

20 decreased gap space when voltage is applied

22 electrical contact point

24 electrical contact point

26 mechanical contact point

28 mechanical contact point

30 mechanical contact point

32 mechanical contact point

34 electrical contact point

36 electrical contact point

38 mechanical contact point

40 mechanical contact point

42 mechanical contact point

44 mechanical contact point

46 electrical contact point

48 electrical contact point

50 mechanical contact point

52 mechanical contact point

54 mechanical contact point

56 mechanical contact point

58 electrical contact point

60 electrical contact point

62 mechanical contact point

64 mechanical contact point

66 mechanical contact point

68 mechanical contact point

70 modular actuator unit with enclosure

72 rigid wall of actuator enclosure

74 top of enclosure

76 top of enclosure

78 orifice

80 output shaft

82 bottom of enclosure

84 microgripper

86 gripping tips

88 flexure

90 pedestal

92 rigid plate

94 flexure

96 beam

98 flexure

100 beam

102 flexure

110 grounded plates

112 nonconducting foam

114 high potential plates

116 electrical connection beam of grounded plate

118 electrically conducting connection between grounded plates

120 electrical connection beam of high potential plate

122 electrically conducting connection between high voltage plates

130 plate/suspension unit geometry for actuator with integrated rigid wall

132 electric contact tab

134 plate

136 frame

138 suspension beam

140 thick oxide insulator spacer

142 thin oxide stops

144 electrical connector to tabs of grounded plates

146 electrical connector to tabs of high voltage plates

148 base of enclosure

150 top of enclosure

152 orifice

154 output shaft

### SUMMARY

The invention provides an electrostatic actuator capable of high force and high displacement by having a plurality of identical conductive plates stacked such that adjustment plates are rotated 90 degrees with respect to each other and are mechanically connected, but electrical connection is only made to alternating plates, which have a relative rotation of 180 degrees. The unique geometry of the plates with peripheral connecting beams makes this possible. The basic element of the design is the plate and suspension beam geometry which is made from a single piece of silicon. The cantilever suspension beams are located at the perimeter of the plate. High force is due to the large confronting area of adjacent plates, which have opposite voltage polarity applied. High displacement of the stack as a whole is due to the cumulative displacement of all the individual plates.

### DESCRIPTION OF THE INVENTION

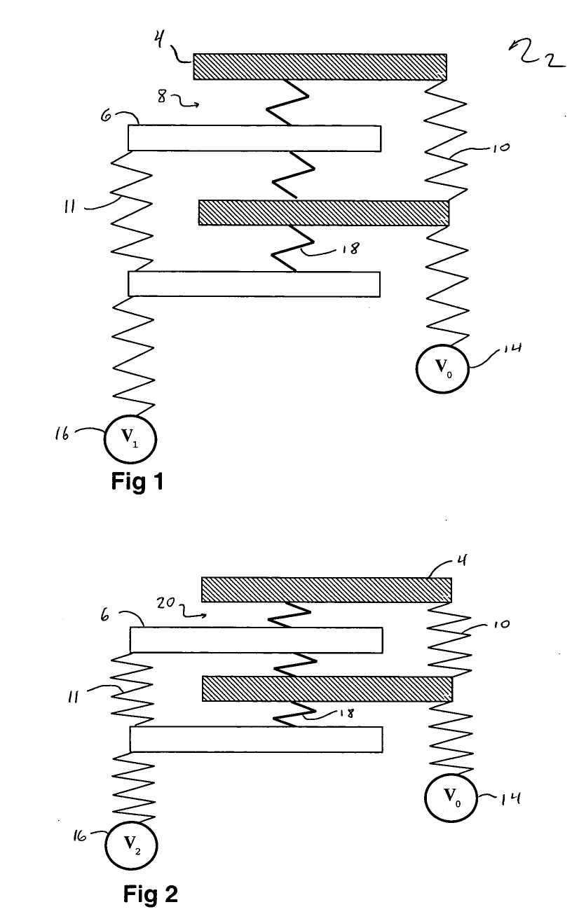

The essence of the invention is shown schematically in side view in FIG. 1. There is a stack (2) of parallel plates (4,6) held together by compliant beams (which function as spring elements). Adjacent plates are connected mechanically, but not electrically. Mechanical spring elements (18) are electrically insulated such that charge cannot flow between adjacent plates. The plates (4, 6) are electrically conductive. There are electrically conducting connections (10) configured such that electrically there are two sets of plates. In FIG. 1, one set of plates (4) is shown as cross hatched. The other set of plates (6) is shown as white. These two sets of plates are electrically insulated from each other and form a capacitor that is mechanically flexible in its axial direction. A different electrical potential can be applied to each set of plates so that there is a potential difference (voltage) between them. In FIG. 1 plates (4) are connected to an electrode at potential V0 and plates (6) are connected to another electrode at potential V1. Adjacent plates can be made oppositely charged so that they attract each other. A charged plate (4) is separated from the adjacent oppositely charged plate (6) by a gap (8). In normal use, V0 would be grounded, and a positive or negative voltage would be applied at the other electrode (V1).

FIG. 2 shows the same side view as FIG. 1, but with increased applied voltage ((V2−V0)>(V1−V0)). The distance between adjacent parallel plates decreases as the applied voltage (and therefore surface charge density) increases on the plates. Thus the gap spacing (8) at a low voltage (V1) will be greater than the gap spacing (20) at a higher voltage (V2). The charging process is reversible, as is the resulting elastic deflection of the connecting spring elements (10, 18), so the actuation cycle can be repeated indefinitely.

The number of plates assembled to build the actuator can be varied to meet the requirements of a given application. There must be at least two plates. In principle there could be thousands of plates in an actuator. In practice, a typical number of plates would be between about 10 and about 100.

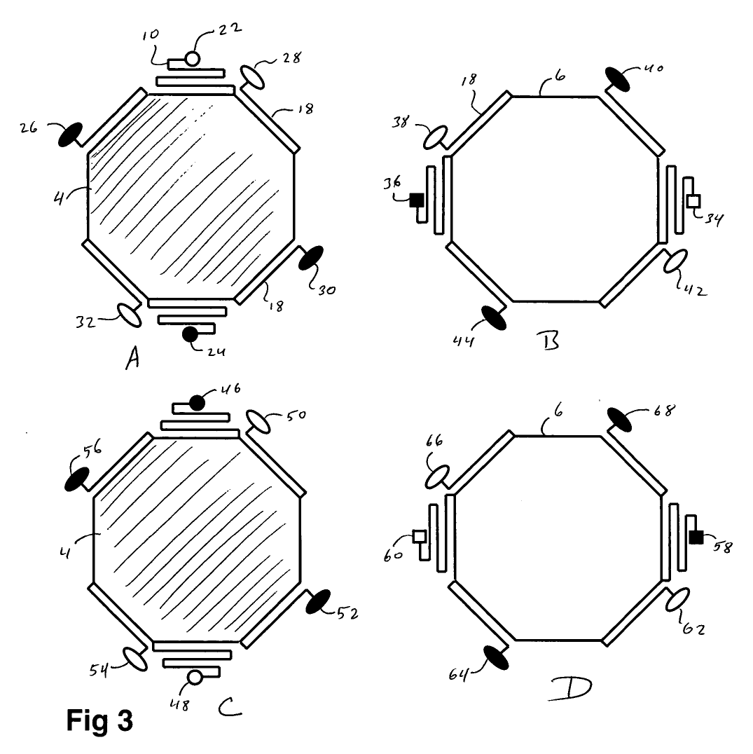

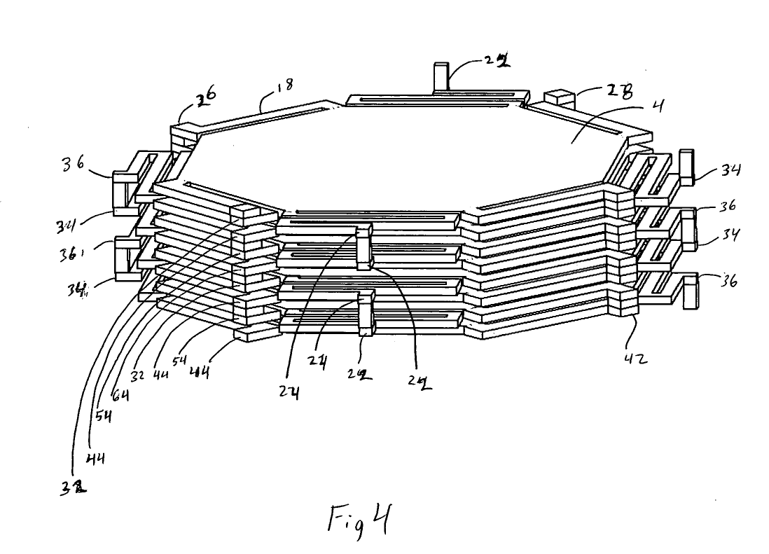

FIGS. 3(a,b,c,d) schematically show the elements of the plate design. Due to the symmetry needed in rotating and stacking the plates, the plates are octagonal. At the periphery of the octagon are the spring elements (cantilevered beams in this case) that provide the mechanical and electrical connections that hold the stack together with axial flexibility, and route the electrical charge properly. The stiffness of the spring elements is calculated to provide the desired displacement along the axial direction of the stack as a function of the applied voltage.

FIGS. 3a, 3b, 3c, and 3d schematically show the stacking orientation of the plates. The stacking sequence is 3a, 3b, 3c, 3d, 3a, 3b, 3c, 3d, . . . , and can be continued indefinitely. The plates are physically identical, but the schematic coding used here has different symbols to show the different connections: mechanical connections are shown as ellipses (26, 28, 30, 32, 38, 40, 42, 44, 50, 52, 54, 56, 62, 64, 66, 68). Note that when the four plates that comprise a full period of the stacking sequence (3a, 3b, 3c, 3d) are superposed in a stack the ellipses line up with other ellipses above and below them. Each white ellipse would be connected to the black ellipse located immediately above it, and each black ellipse is to be connected to the white ellipse located immediately below it. This way each plate is mechanically connected to the plate immediately below it, and to the plate immediately above it. The electrical connections are shown as circles (22, 24, 46, 48) for the set of plates (4) that is electrically grounded, and as squares (34, 36, 58, 60) for the set of plates (6) that will have a variably applied voltage with respect to ground. A white circle is connected to the nearest black circle located above it, and a black circle is connected to the nearest white circle located below it. Similarly, a white square is connected to the nearest black square above it, and a black square is connected to the nearest white square located below it. It can be seen that within a given 4-plate period the pattern of mechanical connections is as follows: (30-42), (26-38), (40-50), (44-54), (52-62), (56-66). And the pattern of electrical connections is as follows: (24-48), (36-60). Connector 60 (black square) would be connected to the white square that would lie below it in the next underlying stacking sequence period, and connector 34 (white square) would be connected to the black square that would lie above it in the next overlying stacking sequence period.

The plate does not have to be an octagon (it can be a hexadecagon, or a circle for example), but it must have at least two electrically conducting connections: one at the 0 degree position, and one at the 180 degree position, and at least 4 electrically insulated connections: one at each of: the 45 degree, 135 degree, 225 degree, and 315 degree positions. This is making use of a coordinate system that is locally defined on each plate such that the electrically conducting beam that connects to the 2^{nd} plate below is called the 0 degree position and the direction of increasing angle is clockwise.

FIG. 4 shows a perspective view of the stack that results from the above instructions. Notice how the physical pathway for the electric current meanders from one side of the stack to the other as it goes up the stack. Also notice that since the positive electrical pathway beams are rotated 90 degrees from the negative electrical pathway beams they do not interfere with each other or have risk of touching each other.

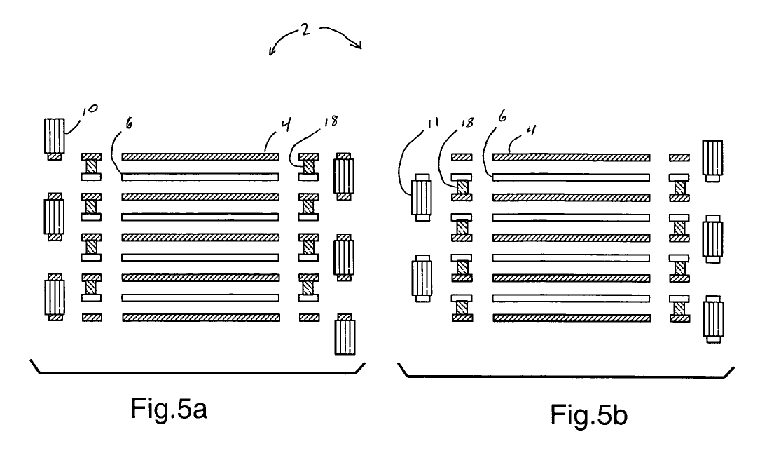

FIG. 5a shows schematically the electrical connections and mechanical connections in side view cross section from one orientation (say the front), and FIG. 5b in schematic cross section shows the connections as viewed from another orientation (say from the right side) which is 90 degrees from the 5a view. Again, notice how the physical pathway for the electric current meanders from one side of the stack to the other as it goes up the stack.

In FIG. 5a the electrical connections (vertical hatched) between the grounded set of plates (4) having the upward sloped hatch, and the mechanical connections (downward sloping hatch) to the oppositely chargeable plates that are immediately below them can be seen. The other set of mechanical connections, the connections to the oppositely chargable plates that are immediately above the aforementioned hatched plates are seen when viewed from the orientation of FIG. 5b.

In FIG. 5b the electrical connections between the set of plates (6) having no hatching are seen.

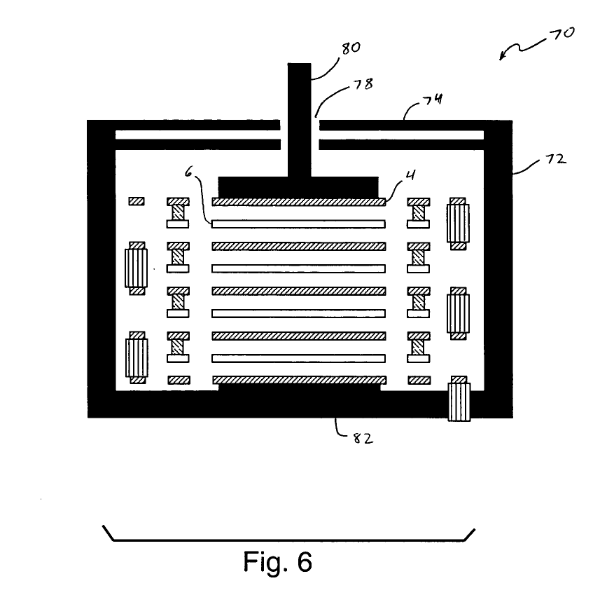

FIG. 6 shows schematically in cross section an actuator module (70) having a protective enclosure (72) that would normally be required to keep particles or other contaminants from getting between the plates and interfering with their relative motion. The enclosure has a base portion (82), and a top portion (74, 76). The output beam (80) that would connect the moving members of the actuator to the load that is to be acted on, goes through an orifice in top portion (74, 76) without making any contact so that friction is avoided. Notice that both of the connections between the enclosure structure and the stack (top plate and bottom plate) are to the grounded set of plates. This keeps the high voltage side of the actuator (electrically a capacitor) isolated from the rest of the system. To further prevent the entry of contaminants, orifice (78) may be filled with grease that occupies the volume located between shaft (80) enclosure top members (74) and (76).

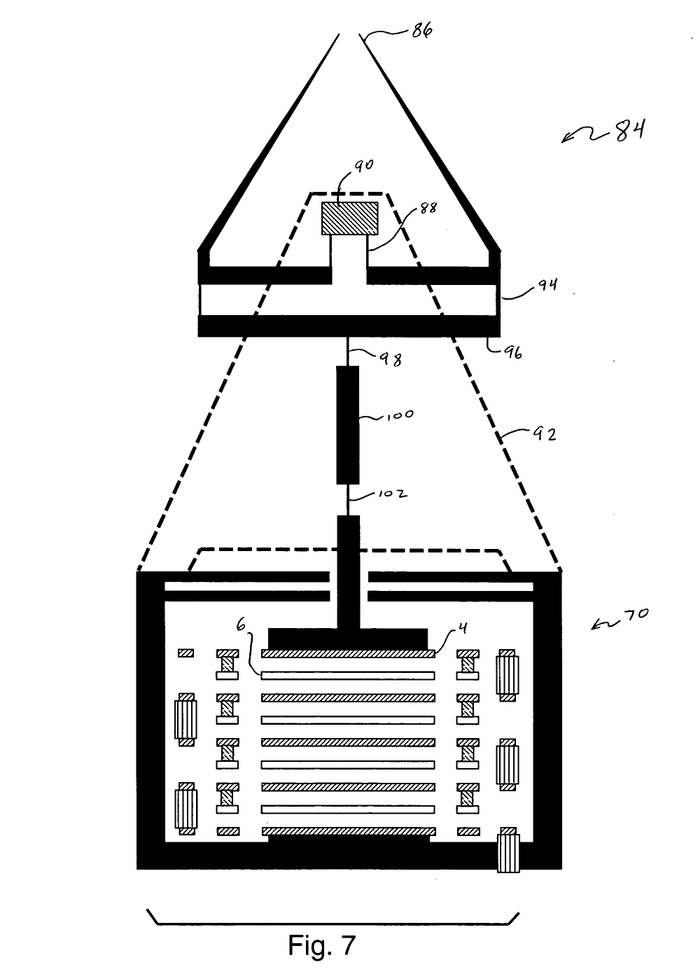

FIG. 7 shows an actuator in a protective enclosure and installed on a micromechanical device (in this case a microgripper (84)). The microgripper has gripping tips (86) which are rotatably supported by flexures (88) and flexures (94). Flexures 88 in turn are supported by pedestal (90) which is rigid anchored to rigid plate (92). The other end of flexures (94) are connected to beam (96). The actuator pulls on flexure (102) which pulls on beam (100), which in turn pulls on flexure (98), which in turn pulls on beam (96), which in turn pulls on flexures (94) to cause the tips (86) to rotate away from each other so that an object to be gripped can fit between the tips. The actuator can only act to pull when voltage is applied. The restoring force that returns the gripper tips to their original closed position comes from the elastic spring elements which are allowed to relax as the applied voltage is reduced.

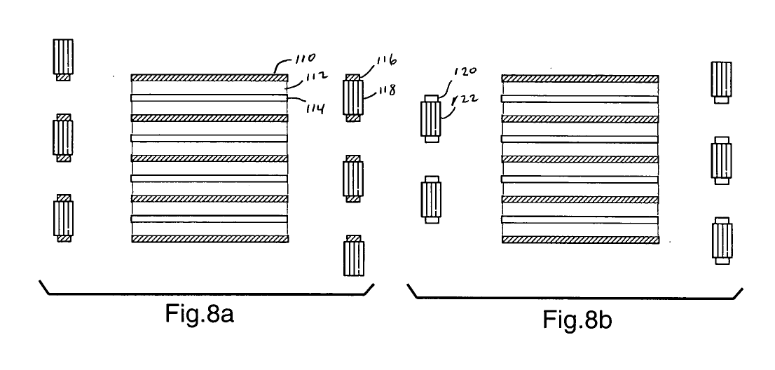

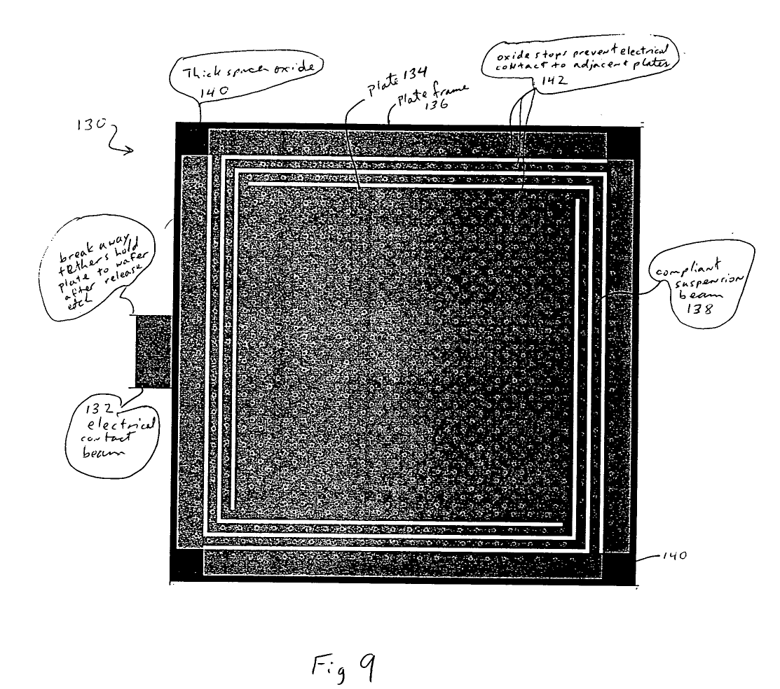

FIG. 8a schematically shows a cross section side view of an embodiment in which the gaps between the plates are filled with a compressible medium (112) such as silica aerogel. In this case the compressible material performs the role of the electrically insulated mechanical spring element (i.e. the cantilevered beam in the embodiment of FIG. 3) mentioned above regarding FIGS. 1-7. In FIG. 8b the viewing direction is rotated 90 degrees from 8a (these views are analogous to the views of the embodiment in FIGS. 5a and 5b). FIG. 8a reveals the electrical connections (118) between the compliant electrical connecting beams (116) of the grounded plates (110). FIG. 8b reveals the electrical connection (122) between the high voltage plates.

In this case the mechanical suspension beams used in previous cases can be augmented or entirely replaced by the slab of compressible material. The material holds the plates apart, but when an actuation voltage is applied to the plates the electrostatic attraction between adjacent plates will compress the material in the gap as the plates move closer together. The greater the voltage, the closer together the plates will move. For a material to have the large compressibility needed for such an actuator there has to be a lot of porosity, or void space. This requirement can be met by an open cell foam, closed cell foam, or fibrous mat. The preferred embodiment would have an open cell foam which can be an aerogel (e.g., silica aerogel), or oxidized porous silicon.

It is important for the gap filling material to be sufficiently insulating to not have significant charge moving through the gap perpendicular to the plates (i.e., away from one plate and closer to the other plate). It is also important to have enough conductivity to avoid the build up of trapped charges in the insulator.

The methods of mechanical engineering can be used to design the device so that it will move as desired under the prescribed loads and voltages of any given application.

FIGS. 9 through 11 show an actuator stack with square or rectangular plates. The interconnection strategy between plates does not have the meandering electrical pathway of the previously described embodiments of FIGS. 1-8. The electrical pathway suspension beams have to be compliant enough to accommodate the whole motion of the actuator since the rigid electrical connector runs the whole length of the actuator.

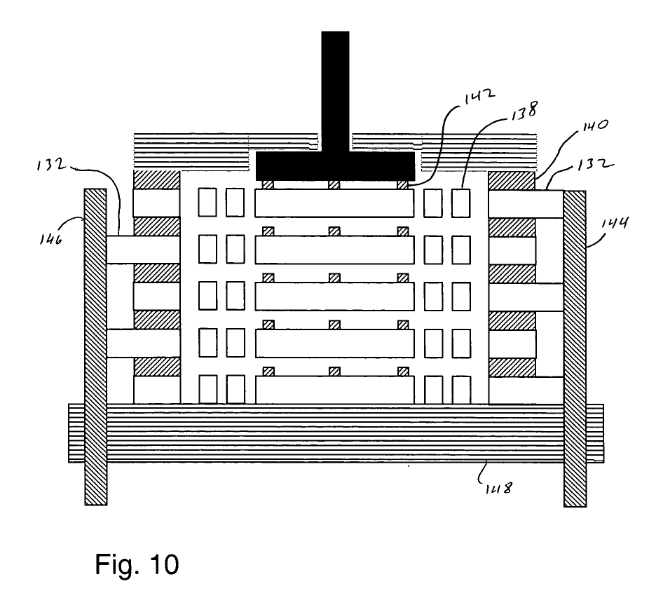

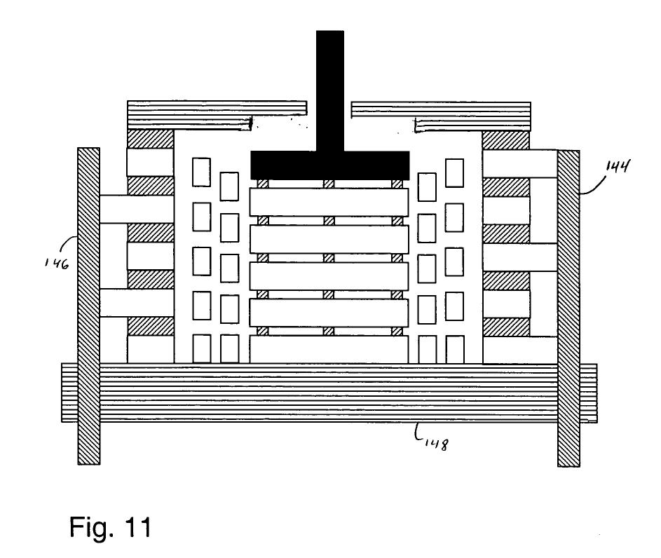

FIG. 9 shows the geometry for the stackable unit design. FIGS. 10 and 11 show cross sections of an actuator produced by stacking up the plates of FIG. 9. In FIG. 10 the applied voltage is 0 so there is no deflection of the plate suspensions (138) (seen as rectangles in cross section). In FIG. 11 the applied voltage is sufficient to produce the maximum deflection of the actuator. In this state the bottom of each plate is contacting the oxide stop structures (142) on the top of the plate below it. Since the oxide is not conductive, there is no electrical short circuit produced by this contact between plates of opposite charge. The rigid square outer wall of the stack results from the combination of the thick oxide (140) (e.g., 2 microns) at the perimeter of the plate frame (136) and the thickness of the silicon of the plate layer. The thickness of the oxide stops (142) is less than the thickness of the thick spacer oxide (140). The layers are bonded together (e.g., by nonconductive epoxy, or reflowed glass frit). FIG. 11 shows the suspension beams deflected since the plates they are attached to have moved. Silver epoxy can be applied to connect the electrical contact tabs (132) projecting from one side of the stack for each of the two polarities (+ and −, or equivalently, V and Ground). Depending on the desired behavior, the design of this device requires calculating the suspension stiffness needed for each plate position to get the desired deflection for a given voltage and applied load in the application of interest. For example, all plates and suspensions could be identical. In an alternative design, the successive layers of suspension beams could have progressively increasing stiffness in going from the output end to the base end.

The present invention has two or more electrically conductive plates. Adjacent plates are separated by a dielectric which is mechanically compressible (e.g, an inert gas such as air, nitrogen, sulfur hexafluoride, vacuum, argon, or an open cell foam such as aerogel or oxidized porous silicon).

Examples of materials used in the embodiments for the electrically conductive parts are: silicon, diamond, or silicon carbide, any of which can be doped with electron donors or electron acceptors to achieve the desired value of electrical conductivity.

Hard stops to prevent contact between plates of opposite polarity can be for example:

1. patterned silicon dioxide, or silicon nitride

2. dispersion of particles with prescribed maximum diameter

### OPERATION OF THE INVENTION

To operate the invention a voltage is applied such that one set of conductive plates in the stack is negatively charged, and the interleaved set of conducting plates is positively charged. This means that adjacent plates are oppositely charged and attract each other with an electrostatic force. Since the stack is flexible, and the dielectric, or gas, between the plates is mechanically compressible, the stack contracts, becoming shorter in its axial dimension. The displacement of this contraction can be increased by increasing the magnitude of the applied electrical voltage. When the voltage is decreased, the electrostatic attractive force decreases, and the stack gets longer again due to the spring force of the elastic supporting members.

How to Build the Invention:

Following are some example methods to construct various example embodiments of the invention.

Silicon Plates With Thermal Oxide Stops:

1. clean single crystal silicon wafers

2. grow 2 microns thermal oxide (wet oxidation, 1100 C)

3. spin on photoresist (PR), pattern for thick oxide spacers, hard bake

4. timed wet HF etch to thin exposed oxide to 0.5 microns

5. spin on PR, pattern to cover thick and thin oxide, hard bake

6. timed wet HF etch to expose bare silicon areas.

7. spin on PR, pattern for anisotropic plasma etch, hardbake

8. plasma etch (e.g., by Bosch process in an STS etcher) to desired depth (e.g., 2 to 20 microns)

9. remove PR

10. grow 0.25 micron thermal oxide (wet oxidation, 1000 C)

11. remove oxide from backside of wafer (leaving a ring at the OD so thick silicon remains there for handling purposes) (protect front side, and apply 5% HF to back)

12. etch exposed backside silicon in 25% TMAH at 50 C until structures are released (still attached to wafer by breakaway tethers)

13. attach patterned oxide side to lapping plate with suitable wax

14. lap etched side flat and then polish.

15. melt wax, remove wafer, clean in solvent.

16. remove 0.25 micron oxide (unmasked blanket etch in 5% HF)

17. remove plates (by breaking tethers) and assemble stack in alignment fixture

18. bond stack together (e.g. with nonconductive epoxy)

19. use silver epoxy to bond connections of the positive plates electrically

20. use silver epoxy to bond connections of the negative plates electrically

Note that if silicon-on-insulator (SOI) wafers are used, the lapping and polishing operations can be avoided (but the initial wafers cost more).

How to Apply Particles to Provide Mechanical Stops:

For bare silicon structures, this can be done after assembly of the stack.

The silicon assembly is exposed to a dispersion of particles in gas, vacuum, or liquid such that particles contact all surfaces of the structure and can adhere to it by surface forces. The distribution of particle size is carefully controlled. In particular, the absolute maximum dimension allowed is the desired distance of closest approach between two adjacent plates. The locations of the particles on the surfaces can be random. The population density must be great enough so that there are no locations with an unsupported span long enough to deflect and contact the adjacent oppositely charged member (plate, or compliant suspension beam) and cause an electrical short circuit in the device. To insure that the particles remain fixed to the surface they should be bonded (for example by sintering, or by a thin film of any kind of glue material). The particles may be rigid or compliant. Example particle materials are silicon dioxide, silicon nitride, diamond, or glass. If application is done in a liquid, the nonvolatile glue material may be dissolved in the liquid so that it remains to glue down the particles after the solvent is removed (e.g., by evaporation, or sublimation).

Silicon Plates With Oxidized Porous Silicon:

1. clean single crystal silicon on insulator (SOI) wafers

2. spin on photoresist

3. pattern photoresist, hardbake

4. anisotropic plasma etch with vertical side walls to buried oxide layer

5. remove photoresist, clean wafer

6. use HF to dissolve buried oxide under device structure to release the device still held to wafer by breakaway tethers

7. rinse wafer in deionized water.

8. connect wafer in electrolytic cell with 5% HF and galvanstat with the etched thin plates as the anode to form a thin (e.g., 0.2 micron) layer of porous silicon with controlled porosity.

9. rinse with DI water, use CO2 critical point drying to avoid stiction

10. grow thermal oxide to oxidize the porous silicon to make desired porous oxide

11. remove parts as needed by gripping part and pulling strongly enough to break the tethers holding it in place.

12. stack the plates up to build an actuator.

13. connect the ends of the electrical pathway beams (e.g., using silver epoxy to contact the spots where the tethers broke and conductive silicon is exposed)

Silicon Plates With Aerogel:

1. clean single crystal silicon wafer

2. spin on PR and pattern for shape of plates and electrical contact beams

3. anisotropic etch to desired depth in silicon (e.g., use Bosch process)

4. remove PR

5. grow 1 micron thermal oxide (wet oxidation 1000 C)

6. protect patterned side and remove oxide from back of wafer with 5% HF

7. put wafer in 50 C TMAH (25% by wt in H2O) to release structures (still tethered to wafer)

8. wax to lapping plate, lap TMAH etched surface flat and polish it.

9. melt wax, clean wafer in solvent

10. apply aerogel precursor (e.g., by dipping)

11. form aerogel of desired thickness (e.g., 1 micron) and desired porosity

12. grip a plate, break its tethers, remove it from the wafer

13. assemble plate to actuator in stack

14. make electrical connections (e.g., using silver epoxy) at ends of adjoining electrical beams where conductive silicon is exposed where tethers were broken off

In this case the plates will be separated by stretching the stack to mount it in the machine it will actuate.

Note that for all of the above constructions, wafer to wafer assembly is possible. Then all of the actuator parts on a wafer are added to actuator stacks simultaneously, and many actuators are assembled at the same time. But this requires much more expensive tooling and fixturing than assembly at the single piece level (one actuator at a time).

Actuator Position Control:

There is a large literature on the control of parallel plate electrostatic actuators. Any of the known methods could be used with this invention described here.

What is claimed:

1. An electrostatic actuator having at least 4 parallel plates, each plate having at least 6 cantilever beams at its perimeter such that at least four beams having electrically insulating connections are located at the 45, 135, 225, and 315 degree positions, and at least 2 electrically conducting beams with electrically conducting connections located at the 0 and 180 degree positions such that the beams located at the 45, and 225 degree positions connect to the adjacent plate immediately above, and the beams at the 135, and 315 degree positions connect to the adjacent plate immediately below, and the beam at the 0 degree position connects to the 2^{nd} plate above, and the beam at the 180 degee position connects to the 2^{nd} plate below it.

2. The electrostatic actuator of claim 1 having an open cell foam located between the plates, said open cell foam made from one of: silica aerogel, oxidized porous silicon,

3. An electrostatic actuator having at least 4 parallel plates, each plate having an electrically conductive cantilever beam at the 0 degree position and at the 180 position, and all adjacent plates are separated by a layer of open cell foam made from one of: silica aerogel, osidized porous silicon

4. an electrostatic parallel plate actuator having rigid walls that is built up by stacking layers having a square frame and four cantilevered suspension beams supporting a square plate
